(19) United States
(12) Patent Application Publication
(10) Pub. No.: US 2002/0032945 A1
(43) Pub. Date: Mar. 21, 2002

(54) Rubber element for wiper blade

(76) Inventor: Rikio Miyamoto, Nagasaki Prefecture (JP)

Correspondence Address: JORDAN AND HAMBURG LLP, 122 East 42nd Street, New York, NY, 10168, US

(21) Appl. No.: 09/729,492

(22) Filed: Dec. 4, 2000

(30) Foreign Application Priority Data
Jul. 10, 2000 (JP) 2000-207838

(51) Int. Cl. B60S 1/38

(52) U.S. Cl. 15/250.41; 15/250.48

(57) ABSTRACT

In an elongated rubber element for a wiper blade, including a base portion fixed to the wiper blade, a neck portion, and three lip portions in which a central lip is suspended from the base portion through the neck portion at a central portion of the underside of the base portion, while lateral lips are branched off from the central lip on lateral sides thereof so as to extend substantially parallel to the central lip, the lateral lips being smaller in length than the central lip, the improvement wherein the lateral lips are formed with respective cutouts in a longitudinal direction of the lateral lips at arbitrarily spaced intervals, the cutouts being open at respective bottom edges of the lateral lips. The above structure allows the rubber element to be readily held in uniform contact with a curvilinear windshield surface.

### BACKGROUND OF THE INVENTION

This invention relates to a rubber element for use on a windshield wiper for squeezing a windshield or rear windshield surface of various vehicles such as automobiles.

FIG. 13 illustrates a typical prior art wiper blade rubber element “a.” The rubber element “a” includes a single lip portion “b.” The lip “b” is reciprocated on a windshield surface “c”, thereby wiping off dirt and debris particles therefrom.

However, the single lip “b” is impossible to remove such dirt at one stroke of the rubber element “a” when the windshield surface “c” is soiled. In addition, in order to wipe the windshield surface “c” as fast as possible, there is no other way but reciprocating the rubber element “a” at increased speed. This causes a problem that the rubber element “a” is unmovable over a limited speed, with the result of accelerated wear of an edge of the lip “b” in a longitudinal direction thereof.

In order to scrape off the dirt and debris particles as much as possible at one stroke of the rubber element “a”, a rubber element having a plurality of lip portions “b” has been developed.

With regard to this type of a rubber element, an application filed by the Applicant of the present Specification was then published as Japanese Patent Application Laid-Open No. 5-358516. FIG. 14 illustrates the rubber element according to the above application. The rubber element includes a fixed portion “e”, a neck portion “f”, and three lips. The fixed portion “e” has a substantially H-shaped cross-section. The fixed portion “e” is formed with grooves “d” for engagement with a holder of a windshield wiper. The neck “f” has a relatively small width. The lips include a central lip “g” and lateral lips “h.” The lip “g” is suspended from the fixed portion “e” through the neck “f” at a central portion of the underside of the fixed portion “e.” The lateral lips “h” are branched off from the central lip “g” on lateral sides thereof.

The above rubber element has the central lip “g” held in constant contact with the windshield surface “c.” When the rubber element is moved reciprocally, then the central lip “g” is tilted laterally about a connection “t.” The connection “t” is formed between the fixed portion “e” and the lips “g” and “h.” Then, adhering particles “i” are wiped off from the windshield surface “c” by means of one of the lips “h”, which is located in a direction in which the rubber element is moved. Thereafter, the central lip “g” successfully removes the adhering particles “i” from the windshield surface “c”, even when the above lateral lip “h” fails to clear away a full of such debris particles “i” from the windshield surface “c.” Such a two-step process allows for more complete removal of the adhering particles “i” from the windshield surface “c.”

Since a windshield or rear windshield is curvilinear, not planar in shape, an edge of the elongated rubber element must be held in uniform contact with such a curvilinear windshield surface. For this reason, the rubber element is made of relatively flexible rubber.

FIG. 15 illustrates single lip rubber element uninterruptedly pressed against the windshield surface “c” by means of a spring on a blade holder. Meanwhile, FIG. 16 illustrates the rubber element having three lips provided thereon, in which the lateral lips “h” does not directly contact the windshield surface “c.” This structure causes a further problem in that an urging force always drives lateral lips “h” in a direction opposite to the windshield surface “c”, thereby precluding the central lip “g” from snugly contacting the windshield surface “c.”

In addition, when the rubber element with the three lips is reciprocated on the windshield, then the lateral lips “h” are tilted laterally about the central lip “g”, and then one of the lips “h” positioned in a direction in which the rubber element is moved, is pressed against the windshield surface “c.” However, this construction brings about another problem that the spring on the holder exerts lesser pressure on the lateral lips “h” than pressure on the central lip “g”, with the result that the lateral lips “h” are in non-uniform contact with the windshield surface “c.”

### SUMMARY OF THE INVENTION

In order to obviate the above problems, an object of the present invention is to provide a rubber element for a wiper blade, having lateral lip portions nicked in order to hold the rubber element in firm contact with a curvilinear windshield or rear windshield surface.

As defined in claim 1, an aspect of the present invention provides an elongated rubber element for a wiper blade, including a base portion fixed to the wiper blade, a neck portion, and three lip portions in which a central lip is suspended from the base portion through the neck portion at a central portion of the underside of the base portion, while lateral lips are branched off from the central lip on lateral sides thereof, the lateral lips being smaller in length than the central lip, the improvement wherein the lateral lips are formed with respective cutouts in a longitudinal direction of the lateral lips at arbitrarily spaced intervals, the cutouts being open at respective bottom edges of the lateral lips.

As claimed in claim 2, another aspect of the present invention provides a rubber element for a wiper blade as defined in claim 1, wherein the lateral lips are positioned substantially parallel to the central lip.

As claimed in claim 3, a further aspect of the present invention provides a rubber element for a wiper blade as defined in claim 1 or 2, wherein the cutouts are provided in alternating sequence between the lateral lips.

As claimed in claim 4, a yet further aspect of the present invention provides a rubber element for a wiper blade as defined in one of claims 1, 2, and 3, wherein both ends of the neck portion in a longitudinal direction of the rubber element along a predetermined length from both ends of the rubber element are made larger in thickness than the remaining portion of the neck portion.

The rubber element according to the present invention has the lateral lips disposed substantially parallel to the central lip, and further has the former lips made smaller in length than the latter lip. This construction allows the lateral lips to be smoothly tilted about the central lip from one side to the other when the rubber element is reciprocated to provide a wiping action. In addition, the above construction prevents interference between the central lip and the lateral lips, and further allows the rubber element to contact the windshield surface at an optimum angle.

Since the lateral lips are defined with the cutouts at arbitrarily spaced intervals, then the rubber element is able to wipe the curvilinear windshield surface under uniform pressure during the wiping action. In addition, since the cutouts are formed in alternating sequence between the lateral lips, then the reciprocation of the rubber element successfully removes remaining dirt and dirt stripes from the windshield surface, which would otherwise occurs as a result of a cleaning failure due to the presence of such nicks in the lateral lips.

Although dirt and debris particles tend to reside between the central lip and the lateral lips during the wiping action, a combination of the smaller lateral lips and the longer central lip creates a gap between the lateral lips and the windshield surface, and the dirt and debris particles are always driven out through the gap. This structure provides good wiping effects, and further prevents the occurrence of damage to the windshield surface.

In addition, both ends of the neck portion in a longitudinal direction of the rubber element along a predetermined length from both ends of the rubber element are made larger in thickness. This construction prevents the rubber element from being damaged because of breaking at both ends thereof, and thus provides improved durability of the rubber element.

### BRIEF DESCRIPTION OF THE DRAWINGS

FIG. 1 is an end view, illustrating a rubber element for a wiper blade according to the present invention;

FIG. 2 is a descriptive illustration, showing the tilted rubber element;

FIG. 3 is a perspective view, illustrating the rubber element;

FIG. 4 is a side view, illustrating the rubber element defined with cutouts;

FIG. 5 is a side view, illustrating the cutouts formed in alternating sequence between lateral lips;

FIG. 6 is a descriptive illustration, showing a shape of another cutout in the rubber element;

FIG. 7 is a descriptive illustration, showing a shape of a further cutout in the rubber element;

FIG. 8 is a cross-sectional view when seen along a longitudinal direction of the rubber element, illustrating both ends of a neck portion, with an intermediate portion of the neck portion being omitted for clarity of description;

FIG. 9 is a cross-sectional view, illustrating an end of the rubber element;

FIG. 10 is a cross-sectional view, illustrating an intermediate portion of the rubber element;

FIG. 11 is a descriptive illustration, showing the rubber element fitted to a wiper blade;

FIG. 12 is a descriptive illustration, showing how the rubber element is operated;

FIG. 13 is a descriptive illustration, showing a prior art rubber element having a single lip thereon;

FIG. 14 is a descriptive illustration, showing a prior art rubber element having tree lips thereon;

FIG. 15 is a descriptive illustration, showing the prior art rubber element having the single lip thereon, in which the rubber element is held in contact with a windshield surface; and,

FIG. 16 is a partly enlarged side view, showing the prior art rubber element having the the three lips thereon, in which the rubber element is held in contact with the windshield surface.

### DETAILED DESCRIPTION OF THE PREFERRED EMBODIMENTS

Embodiments of the present invention will now be described with reference to the drawings in which the embodiments are illustrated.

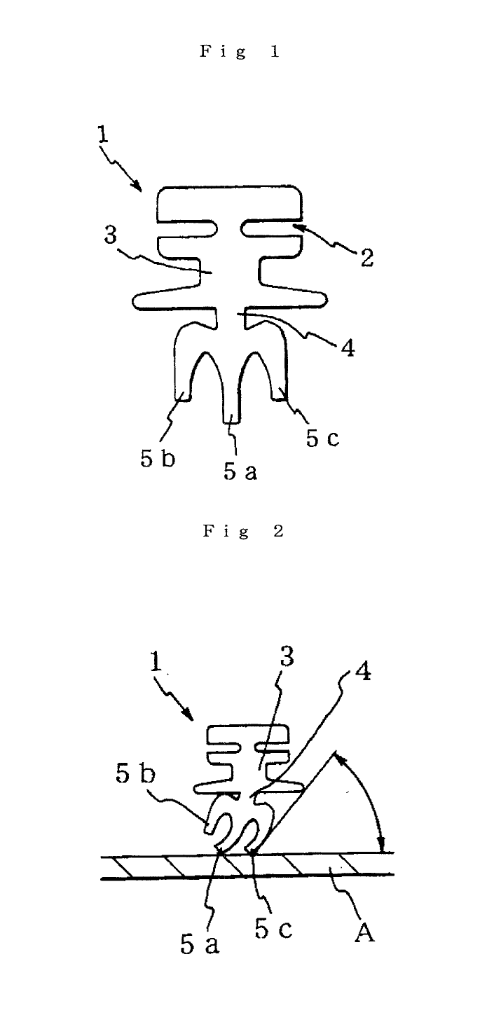

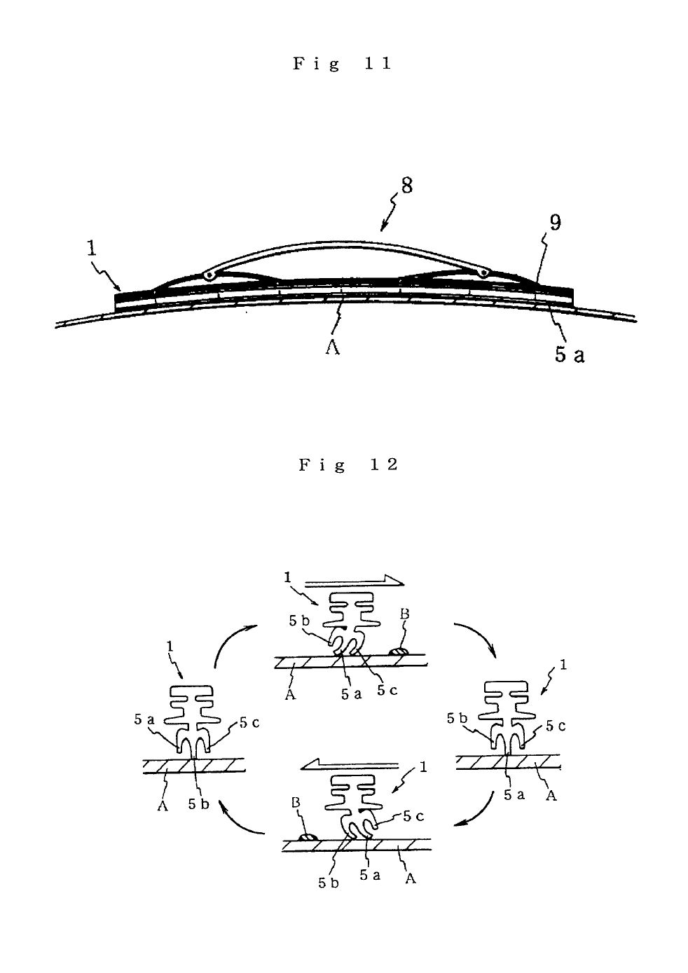

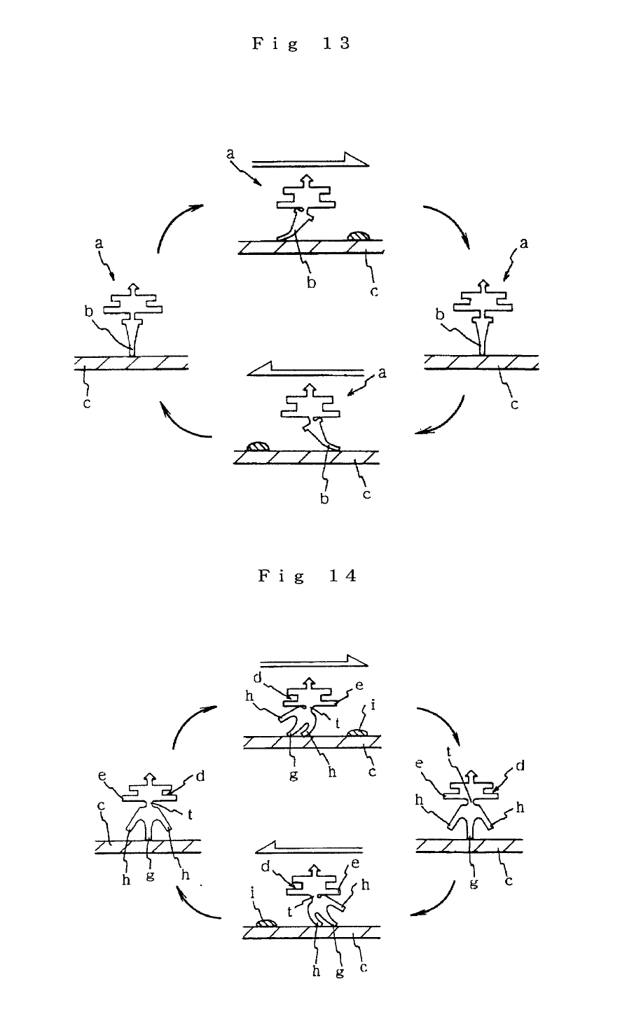

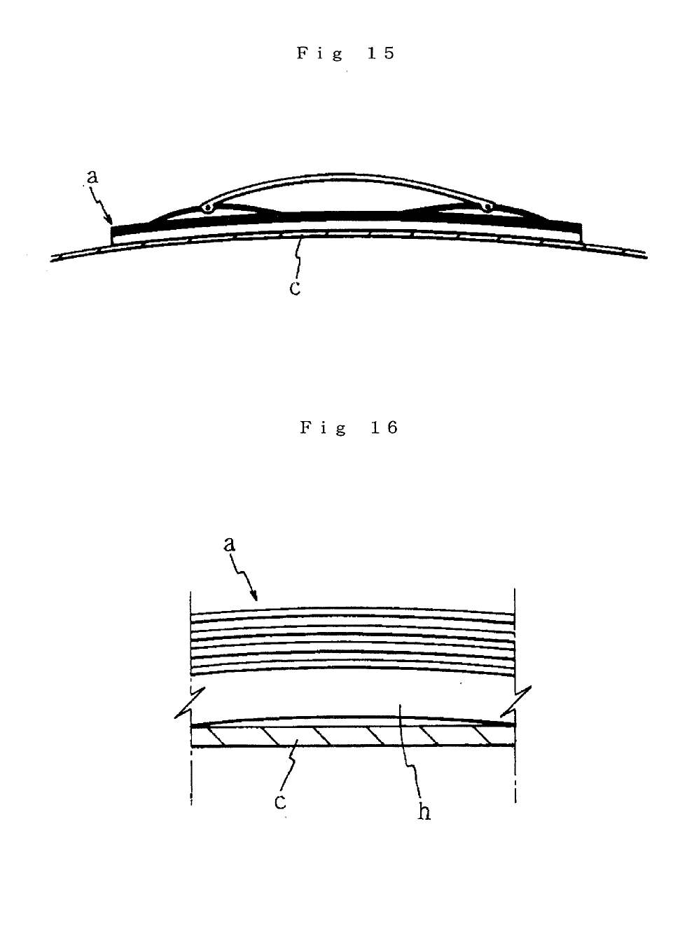

FIG. 1 illustrates a rubber element 1 for a wiper blade 8. (See FIG. 11 for the wiper blade 8.) The rubber element 1 includes a base portion 3, a neck portion 4, and three lip portions 5a, 5b, and 5c. The rubber element 1 is made of a raw rubber material. The base 3 includes groove portions 2, into which a holder 9 (see FIG. 11) of the wiper blade 8 is inserted, thereby securing the rubber element 1 to the holder. The lips 5a, 5b, 5c extend from the base 3 through the neck 4 at a central portion of the underside of the base 3.

The lip 5a is suspended from the neck 4 along the axis of the neck 4. The neck 4 serves as a fulcrum when the rubber element 1 yields a wiping action. The lip 5a is formed integrally with the symmetrical lips 5b, 5c on lateral sides of the lip The lateral lips 5b, 5c are bent at an angle such as to extend substantially parallel to the central lip 5a. In addition, as illustrated in FIG. 2, the lateral lips 5b, 5c are smaller in length than the central lip 5a in such a manner as to be bent at an angle less than 90° about the neck 4 that is bent as well.

A combination of the shorter lips 5b, 5c and the longer lip 5a allows the rubber element 1 to contact a windshield surface “A” at an optimum angle, and further prevents interference between the central lip 5a and the lateral lips 5b, 5c during the wiping action.

Furthermore, respective proximal ends of the lateral lips 5b, 5c are made smaller in thickness than other portions thereof around the aforesaid proximal ends. This construction allows stresses to be concentrated on such thinner proximal ends of the lateral lips 5b, 5c. As a result, the lateral lips 5b, 5c are easily bent about the proximal ends of the lips 5b, 5c as a fulcrum.

Moreover, the lateral lips 5b, 5c are smaller in thickness than the central lip 5a in order to permit the lateral lips 5b, 5c to be readily bent.

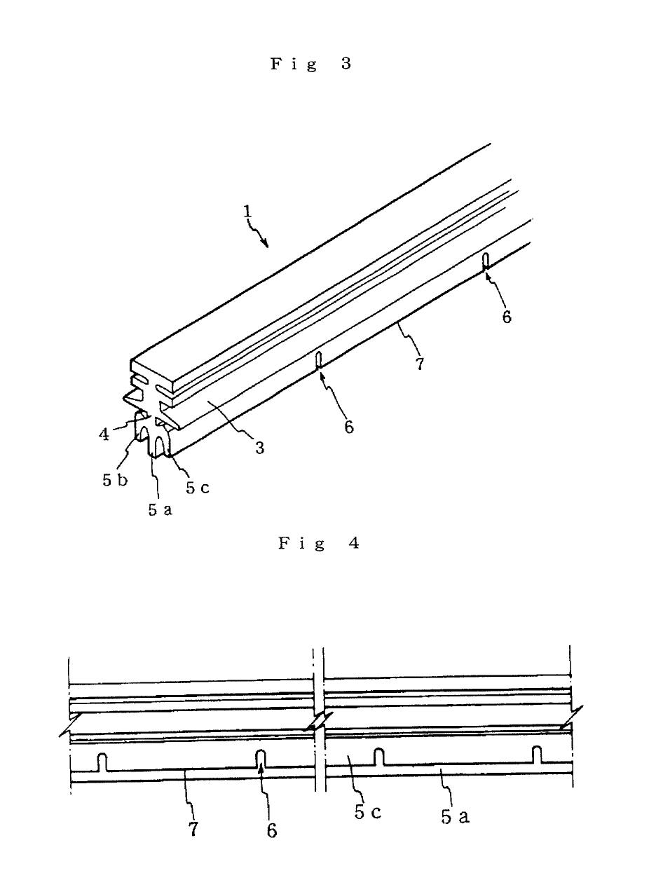

FIG. 3 illustrates the lateral lips 5b, 5c having cutouts 6 formed at regularly spaced intervals in a longitudinal direction of the elongated rubber element 1. As shown in FIG. 4, the cutouts 6 are open substantially halfway from respective edges 7 of the lips 5b, 5c.

In this regard, the cutouts 6 may be formed in an optimum manner, e.g., vertically or diagonally with respect to the edges 7.

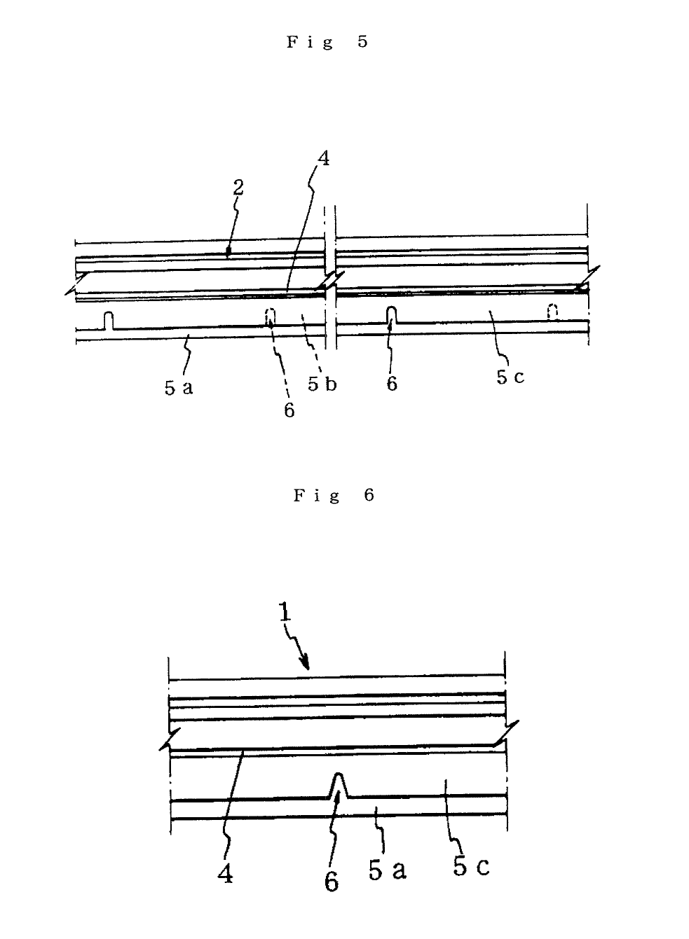

Turning now to FIG. 5, the cutouts 6 are shown positioned in alternating sequence (or in a staggered manner) between the lateral lips 5b, 5c. As a result, although void spaces defined by the cutouts 6 cause one of the lips 5b and 5c to fail to wipe off dirt and debris particles from the windshield surface “A”, the reciprocation of the rubber element 1 allows the edge 7 of the other of the lips 5b and 5c to remove such remaining dirt and debris particles therefrom.

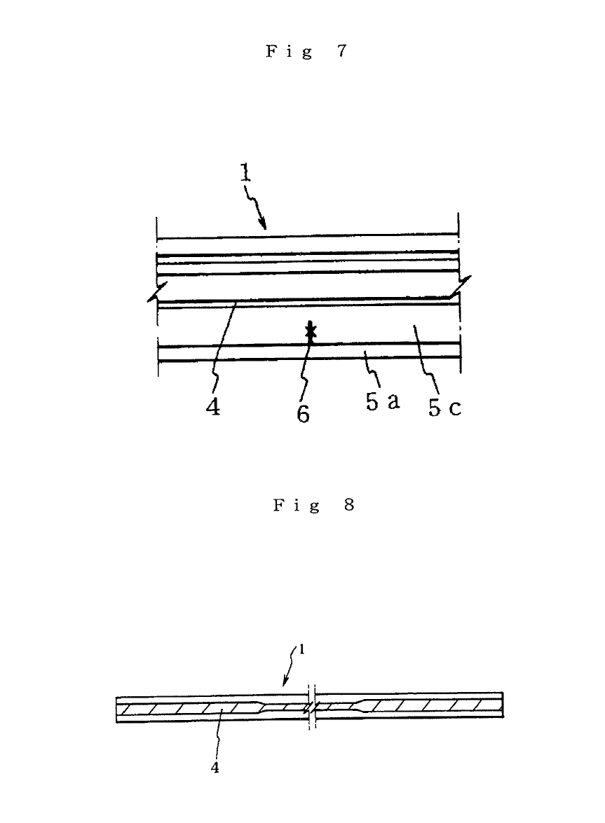

The cutout 6 is not limited to an elongated hole as shown in FIG. 4, but may be triangular in shape as seen in FIG. 6. FIG. 7 illustrates a slit cutout 6 as a further alternative.

The cutouts 6 are spaced apart from each other by a distance such that the lateral lips 5b, 5c are able to uniformly contact the curvilinear windshield surface “A.”

As shown in FIG. 8, both ends of the neck 4 in a longitudinal direction of the rubber element 1 along a definite length from both ends of the rubber element 1 are as much as 1.5 to 2.0 times thicker than the remaining portions of the neck 4.

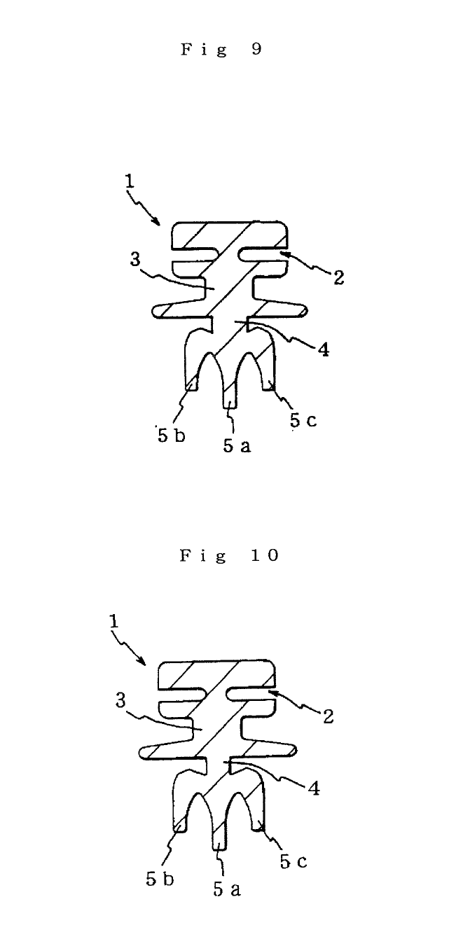

Thus, as seen from FIG. 9, the both ends of the neck 4 are made larger in thickness, when compared with an intermediate portion of the neck 4 as shown in FIG. 10. This configuration allows the rubber element 1 be held in snug abutting contact with the curvilinear windshield surface “A”, and thus provides improved durability of the rubber element 1.

FIG. 11 illustrates the above-structured rubber element 1 according to the present invention fitted to the holder 9 of the wiper blade 8, in which the lip 5a is held in firm contact with the windshield surface “A.”

FIG. 12 illustrates a two-step process during one stroke of the rubber element 1 and another two-step process during a return stroke of the rubber element 1 for providing a wiping action. More specifically, for one stroke of the rubber element 1, the lateral lip 5c at first wipes off dirt or water droplets “B” from the windshield surface “A”, and then the central lip 5a removes remaining dirt and water droplets “B” therefrom.

For the return stroke of the rubber element, the lateral lip 5b at first wipes away dirt and water droplets “B” from the windshield surface “A”, and then the central lip 5a scrapes remaining dirt and water droplets “B” off the windshield surface “A.”

The lips 5b, 5c defined with the cutouts 6 permits the respective edges of the lips 5b, 5c to be brought into positive contact with the curvilinear windshield surface “A” during the wiping action. Such intimate contact further provides enhanced wiping effects.

In addition, since the rubber element 1 according to the present invention has the lateral lips 5b, 5c made smaller in length than the central lip 5a, then the rubber element 1 can smoothly be reciprocated on the windshield surface “A.”

What is claimed is:

1. In an elongated rubber element for a wiper blade, including a base portion fixed to said wiper blade, a neck portion, and three lip portions in which a central lip is suspended from said base portion through said neck portion at a central portion of an underside of said base portion, while lateral lips are branched off from said central lip on lateral sides of said central lip, said lateral lips being smaller in length than said central lip, the improvement wherein said lateral lips are formed with respective cutouts in a longitudinal direction of said lateral lips at arbitrarily spaced intervals, said cutouts being open at respective bottom edges of said lateral lips.

2. A rubber element for a wiper blade as defined in claim 1, wherein said lateral lips are positioned substantially parallel to said central lip.

3. A rubber element for a wiper blade as defined in claim 1 or 2, wherein said cutouts are provided in alternating sequence between said lateral lips.

4. A rubber element for a wiper blade as defined in one of claims 1, 2, and 3, wherein both ends of said neck portion in a longitudinal direction of said rubber element along a predetermined length from both ends of said rubber element are made larger in thickness than any remaining portion of said neck portion.
